(19) United States
(12) Patent Application Publication
(10) Pub. No.: US 2013/0337158 A1
(43) Pub. Date: Dec. 19, 2013

(54) PICKERING EMULSION FOR PRODUCING ELECTRICALLY CONDUCTIVE COATINGS AND PROCESS FOR PRODUCING A PICKERING EMULSION

(71) Applicants: Stefanie Eiden, Leverkusen (DE); Diana Dimova Landen, Leverkusen (DE); Daniel Gordon Duff, Leverkusen (DE); Daniel Rudhardt, Koln (DE)

(72) Inventors: Stefanie Eiden, Leverkusen (DE); Diana Dimova Landen, Leverkusen (DE); Daniel Gordon Duff, Leverkusen (DE); Daniel Rudhardt, Koln (DE)

(73) Assignee: BAYER INTELLECTUAL PROPERTY GMBH, Monheim (DE)

(21) Appl. No.: 13/993,516

(22) PCT Filed: Dec. 19, 2011
(86) PCT No.: PCT/EP2011/073276

§ 371 Date: Sep. 6, 2013

(30) Foreign Application Priority Data
Dec. 21, 2010 (EP) 10196109.2

(51) Int. Cl. C09D 5/24

(52) U.S. Cl. CPC C09D 5/24
USPC 427/125; 252/514

(57) ABSTRACT

The present invention relates to a process for producing a Pickering emulsion comprising water, a solvent not miscible with water, and also, preferably sterically, stabilized silver nanoparticles, for producing conductive coatings. The invention further relates to a process for coating all or part of the area of surfaces, in particular with a Pickering emulsion according to the invention, where the resultant coating in particular has high electrical conductivity and advantageously can also be transparent.

The present invention relates to a process for producing a Pickering emulsion comprising water, a solvent not miscible with water, and also, preferably sterically, stabilized silver nanoparticles, for producing conductive coatings. The invention further relates to a process for coating all or part of the area of surfaces, in particular with a Pickering emulsion according to the invention, where the resultant coating in particular has high electrical conductivity and advantageously can also be transparent.

Plastics components generally have good mechanical properties and also to some extent good optical properties, an example being transparency in the case of polycarbonate. Most engineering plastics are electrical insulators, however.

For many applications of transparent plastics it is desirable, and can be enormously advantageous, to link mechanical properties, such as stability, optical properties, such as transparency, and electrical properties, such as electrical conductivity. The transparency of components is worthy of particular mention here and in many application sectors the intention is to maximize this, examples being glazing in automobile construction or on buildings, or inspection windows in devices, where these are to be used in conjunction with extended electrical applications, an example being an electrical heating system, shielding from electromagnetic radiation or dissipation of surface charge. In most instances the intention is simultaneously to maximize the mechanical stability of the parent material and also design freedom in relation to the shaping process. Another desirable use is as highly conductive electrical conductor in the sector of solar cell technology (photovoltaic systems).

In a known process during processing of silver or of other metals, stabilized nanoparticles are dispersed in organic solvents or in water, and these formulations are then applied to substrates and dried. However, the temperatures required to sinter the stabilized nanoparticles are mostly comparatively high. Some substrates, in particular many plastics substrates, such as those made of polycarbonate, do not tolerate these conditions.

Xia et al. in Adv. Mater., 2003, 15, No. 9, 695-699 describe the production of stable aqueous dispersions of silver nanoparticles with poly(vinylpyrrolidone) (PVP) and sodium citrate as stabilizers, thus obtaining monodisperse dispersions with silver nanoparticles with particle sizes below 10 nm and narrow particle size distribution. The use of PVP as polymeric stabilizer here leads to steric stabilization of the nanoparticles with respect to aggregation. The effect of steric polymeric dispersion stabilizers of this type in the resultant conductive coatings can sometimes be, through occupation of the surfaces of the silver particles, to reduce the amount of direct contact between the particles and thus reduce the conductivity of the coating. According to Xia, it is impossible to obtain stable monodisperse dispersions of this type without using added PVP as stabilizer.

EP 1 493 780 A1 describes the production of conductive surface coatings with a liquid conductive composition made of a binder and silver particles, where the previously mentioned silver-containing particles can be silver oxide particles, silver carbonate particles or silver acetate particles, the size of each of which can be from 10 nm to 10 μm. The binder is a polyvalent phenol compound or one of various resins, i.e. in every case at least one additional polymeric component. According to EP 1 493 780 A1, application of the said composition to a surface, with heating, gives a conductive layer, where the heating is preferably implemented at temperatures of from 140° C. to 200° C. The conductive compositions described according to EP 1 493 780 A1 are dispersions in a dispersion medium selected from alcohols, such as methanol, ethanol and propanol, isophorones, terpineols, triethylene glycol monobutyl ethers and ethylene glycol monobutyl ether acetate. EP 1 493 780 A1 indicates here that it is preferable to add dispersion stabilizers, such as hydroxypropylcellulose, polyvinylpyrrolidone and polyvinyl alcohol in order to prevent aggregation of the silver-containing particles in the dispersion medium. Again, these dispersion stabilizers are polymeric components. Accordingly, the silver-containing particles are always sterically stabilized in the dispersion medium by the previously mentioned dispersion stabilizers and the binder, as dispersion stabilizer in relation to aggregation.

WO2006/13735 A2 and U.S. Pat. No. 7,566,360 B2 disclose a method for producing transparent conductive metal-nanoparticle-based coatings. Here, a nanometal powder is first processed with a plurality of additives, such as surfactant substances, binders, polymers, buffers, dispersing agents and coupling reagents, in organic solvents, to give a homogeneous mixture. The nanometal powders can also be silver nanoparticles. The said homogeneous mixture is then in turn mixed with water or with a solvent miscible with water, thus giving a water-in-oil (W/O) emulsion. This emulsion is directly applied by spraying, printing, spincoating or dipping to the surface to be coated, the solvents are removed and the coating is sintered, whereupon a conductive and transparent coating or structure is obtained. The formation of network-like structures by the metal nanoparticles is also described.

A particular disadvantage of previously mentioned water-in-oil emulsions is that before they can be used they must be washed at least twice with water, if the desired transparent conductive metal-nanoparticle-based coatings are to be produced therefrom.

N. Wakamatsu et al. in Ad. Funct. Mater. 2007, 19, 2535-2539 described the self-organization of CNTs (carbon nanotubes) or SWNTs (single walled carbon nanotubes) to give a honeycomb structure by means of emulsion technology.

The publication by Minzhi Rong, Polymer 40 (1999) 6169 describes the self-organization of silver nanoparticles in polymeric systems.

There continues to be a requirement for alternative processes which can use short drying times and short sintering times and/or low drying temperatures and low sintering temperatures for the coating of surfaces with conductive coatings when using dispersions comprising silver nanoparticles, in such a way that it is also possible to coat heat-sensitive plastics surfaces. The following are also desirable: alternative coating compositions for producing coatings of high electrical conductivity, where these in particular can also have good transparency, and processes which can produce these and which are in particular inexpensive and simple and which by way of example do not require complicated washing or purification of the emulsion before it can be used.

A process for producing a Pickering emulsion for producing conductive coatings is therefore proposed according to the invention, where
a) an aqueous dispersion comprising, in particular sterically, stabilized silver nanoparticles and water is mixed with at least one solvent not miscible with water and then is dispersed to give an emulsion, where the content of stabilized silver nanoparticles, based on the total weight of the resultant emulsion, is from 0.5% by weight to 7% by weight, and
b) by virtue of a creaming process during a standing time, the emulsion obtained in (a) is then separated into an upper concentrated emulsion phase and a lower, in essence aqueous, phase, and
c) the resultant upper concentrated emulsion phase is isolated, where the content of silver nanoparticles in this emulsion phase is up to 7% by weight, preferably up to 4.5% by weight, based on its total weight.

In other words the step (a) according to the invention produces an initial emulsion made of stabilized silver nanoparticles dispersed in aqueous dispersion medium or in aqueous dispersion media, an example being a silver nanoparticle sol, and of water and of a solvent not miscible with water. The said initial emulsion can preferably be an O/W emulsion. In this case, the oil phase of the O/W emulsion is formed by the solvent(s) not miscible with water.

The silver nanoparticles occupy the surface of the oil droplets and stabilize the oil droplets in the emulsion. The stated content of silver nanoparticles in % by weight is based according to the invention on the content of stabilized silver nanoparticles, i.e. on the silver nanoparticles of which the surface has been occupied by dispersion stabilizer.

The aqueous dispersion medium or aqueous dispersion media preferably involve(s) water or a mixture comprising water and organic, preferably water-soluble, solvents. It is particularly preferable that the liquid dispersion medium or liquid dispersion media involve(s) water or a mixture made of water with alcohols, with aldehydes and/or with ketones, particularly preferably water or a mixture made of water with mono- or polyhydric alcohols having up to 4 carbon atoms, e.g. methanol, ethanol, n-propanol, isopropanol or ethylene glycol, with aldehydes having up to 4 carbon atoms, e.g. formaldehyde, and/or with ketones having up to 4 carbon atoms, e.g. acetone or methyl ethyl ketone. Very particularly preferred dispersion medium is water.

For the purposes of the invention, silver nanoparticles are those with a d₅₀ value of less than 100 nm, preferably less than 80 nm, measured by means of dynamic light scattering. An example of equipment suitable for the measurement by means of dynamic light scattering is a ZetaPlus Zeta Potential Analyzer from Brookhaven Instrument Corporation.

According to the invention, the stabilization of the silver nanoparticles in the aqueous silver nanoparticle dispersion used, an example being silver nanoparticle sol, is preferably achieved with a steric dispersing agent, e.g. polyvinylpyrrolidone, block copolyether and block copolyether having polystyrene blocks, very particularly preferably Disperbyk 190 (BYK-Chemie, Wesel).

Use of a dispersing agent gives the silver nanoparticle sols used for producing the Pickering emulsion according to the invention high colloid-chemical stability. The selection of the dispersing agent also permits ideal adjustment of the surface properties of the particles. Dispersing agent adhering to the surface of the particles can by way of example give the particles a positive or negative surface charge.

It is also possible in principle, although less preferred according to the invention, to stabilize the silver nanoparticles electrostatically. For electrostatic stabilization of the silver nanoparticles, at least one electrostatic dispersion stabilizer is added during production of the dispersions. For the purposes of the invention, an electrostatic dispersion stabilizer is one whose presence provides the silver nanoparticles with repellent forces, where the said repellent forces then remove any tendency of the particles towards aggregation. By virtue of the presence and effect of the electrostatic dispersion stabilizer, repellent electrostatic forces operate between the silver nanoparticles and counteract the Van der Waals forces which favour aggregation of the silver nanoparticles.

Particularly preferred electrostatic dispersion stabilizers are citric acid and/or citrates, e.g. lithium citrate, sodium citrate, potassium citrate or tetramethylammonium citrate. In an aqueous dispersion, the salt-type electrostatic dispersion stabilizers are very substantially present in the form of their dissociated ions, and the respective anions here provide the electrostatic stabilization.

Step (b) subjects the initial emulsion from step (a) to a creaming process. During a standing time here, the initial emulsion separates into an upper concentrated emulsion phase and a lower, in essence aqueous, emulsion phase. According to the invention, the upper concentrated emulsion phase is also termed cream phase or cream layer. In other words, the cream phase advantageously comprises a relatively high concentration of droplets of the oil phase, since the oil droplets rise during the standing time.

Finally, the cream phase is isolated in the step (c) of the process according to the invention. The content of stabilized silver nanoparticles in the cream phase can be up to 7% by weight, preferably up to 4.5% by weight, based on the total weight of the isolated Pickering emulsion.

In other words, the cream phase forms the Pickering emulsion according to the invention. The silver nanoparticles here continue to occupy the surface of the oil droplets in the cream phase, and thus an adequate concentration of silver advantageously passes into the cream phase. According to the invention it is therefore possible to ensure that the coating composition obtained is suitable for producing conductive coatings.

When starting concentrations of silver nanoparticles in the initial emulsion are comparatively low, it is advantageously also possible according to the invention that the concentration of silver nanoparticles in the cream phase is higher than the concentration in the initial emulsion. This is particularly advantageous for a cost-efficient coating process, since it is therefore possible according to the invention to produce coating compositions suitable for the production of conductive coatings with comparatively low usage of silver nanoparticles.

The process according to the invention for producing the coating composition, i.e. the Pickering emulsion, is simple and inexpensive to carry out. Surprisingly, it has been found that the Pickering emulsions provided by the process according to the invention moreover are particularly stable and by way of example can be stored for a number of days. Another advantage of the process according to the invention is that the Pickering emulsion obtained in step (c) has excellent suitability as coating composition for producing electrically conductive, and in particular also transparent, coatings on substrates.

The process according to the invention moreover advantageously does not require additional additives, such as binders, dispersing agents and film-formers, where these retard the drying and/or sintering of a surface coating obtained from a Pickering emulsion according to the invention from step (c), or indeed need an increased temperature for onset of drying and/or sintering and thus of conductivity of the surface coating by virtue of sintering of the silver particles.

One preferred embodiment of the process provides that the standing time in (b) is from 1 h to 5 d, preferably from 6 h to 3 d, particularly preferably from 12 h to 36 h, for example 24 h. The said standing times have proved particularly suitable for forming stable Pickering emulsions with good properties for producing conductive coatings.

In another preferred embodiment of the process, the content of the silver nanoparticles in the initial emulsion in (a), based on the total weight of the initial emulsion obtained in (a), is preferably from 0.7% by weight to 6.5% by weight, particularly preferably from 0.7 to 3.0% by weight. By setting the silver nanoparticle content in this preferred range, it is possible in the subsequent steps (b) and (c) to obtain and isolate Pickering emulsions which exhibit particularly advantageous properties for forming electrically conductive coatings. Another particular result of the setting of the silver content in the initial emulsion in the said preferred range, after the Pickering emulsion isolated in (c) has been applied as coating composition, is that self-organization of the silver nanoparticles to give network-like structures is promoted, an example being the formation of honeycomb structures made of these nanoparticles in this type of coating. It is moreover possible that the Pickering emulsions obtained from the said initial emulsions preferred according to the invention also have an increased concentration of silver nanoparticles and a silver nanoparticle content higher than that of the initial emulsion.

With regard to further features of the process according to the invention, explicit reference is hereby made to the explanations provided in connection with the Pickering emulsion according to the invention and in connection with the use according to the invention.

According to the invention, a Pickering emulsion for producing conductive coatings is moreover proposed for achievement of the object of the invention, where the emulsion comprises stabilized silver nanoparticles and water, and also at least one organic solvent not miscible with water, where the amount present of the stabilized silver nanoparticles is from 0.5% by weight to 7% by weight, preferably from 0.7 to 6.5% by weight, particularly preferably up to 5% by weight, for example up to 3.5% by weight, based on the total weight of the emulsion.

The Pickering emulsion provided according to the invention is suitable as coating composition for producing electrically conductive structures, in particular for forming network-like honeycomb structures through self-organization of the silver nanoparticles, and can also advantageously be used for producing transparent electrically conductive structures, in particular continuously connected transparent conductive networks. Advantages of the self-organization of the silver nanoparticles to give honeycomb structures are that no complicated printing process or expensive technologies are required to obtain electrically conductive structures. Furthermore, the honeycomb structures are transparent and/or help to improve the transparency of the resultant structured coating.

As explained above for the purposes of the description of the production process, the Pickering emulsion according to the invention, as coating composition, preferably comprises small sterically stabilized silver nanoparticles which in essence have a d₅₀ of about 80 nm and are present in stable colloidal form in the silver nanoparticle sol used. The Pickering emulsion comprises according to the invention a low concentration of the stabilized silver nanoparticles: from 0.5% by weight to 7% by weight, preferably from 0.5 to 5% by weight, particularly preferably up to 4.5% by weight, for example up to 3.5% by weight, with no additional dispersing agents. This low concentration is also believed to be the cause of the low post-treatment temperature required, 140° C., to achieve surprisingly high conductivities of the resultant structures on a substrate after application and drying of the Pickering emulsion as coating composition.

In one preferred embodiment of the Pickering emulsion according to the invention, this comprises no additional surfactant compounds, binders, polymers, buffers, film-formers or dispersing agents. The Pickering emulsion according to the invention is therefore advantageously free from additional substances which could reduce the conductivity of a coating produced therefrom.

This means that there is no requirement to add any additives, in particular any additional surfactant compounds, binders, polymers, buffers or dispersing agents, in order to obtain a Pickering emulsion suitable for producing electrically conductive coatings. Another advantage of the Pickering emulsion according to the invention is therefore that when it is compared with coating compositions which comprise additional additives, such as surfactant compounds, or further dispersing agents or polymers, it is not only less expensive but also simpler to produce. Another advantage is that steric hindrance of the silver particles by additional additives of this type is avoided, and good conductivity can be ensured for a coating produced from the Pickering emulsion according to the invention, and in particular even at comparatively low post-treatment temperatures.

In one preferred embodiment of the Pickering emulsion according to the invention, the organic solvent involves at least one linear or branched alkane, one optionally alkyl-substituted cycloalkane, one alkyl acetate or one ketone, benzene or toluene. Examples of organic solvents which are suitable according to the invention are cyclohexane, methylcyclohexane, n-hexane, octadecane, ethyl acetate, butyl acetate, acetophenone and cyclohexanone, but this list is not exclusive. When these solvents were used as oil phase, it was possible according to the invention to produce stable Pickering emulsions which have particularly good suitability as coating compositions for producing electrically conductive structures, in particular for forming network-like honeycomb structures through self-organization of the silver nanoparticles.

In another preferred embodiment of the Pickering emulsion according to the invention, the organic solvent and the water are preferably present in a ratio (in % by weight) of from 1:4 to 1:2, in the emulsion, for example in a ratio of 1:3.

For the purposes of one preferred embodiment of the Pickering emulsion according to the invention, the silver nanoparticles introduced by way of example in the form of a silver nanoparticle sol into the Pickering emulsion have steric stabilization by a dispersing agent. According to the invention, the dispersing agent for steric stabilization is preferably one selected from the group of polyvinylpyrrolidone, block copolyethers and block copolyethers having polystyrene blocks. It is particularly preferable to use polyvinylpyrrolidone with molar mass of about 10 000 amu (e.g. PVP K15 from Fluka) and polyvinylpyrrolidone with molar mass of about 360 000 amu (e.g. PVP K90 from Fluka) and it is particularly preferable to use block copolyethers having polystyrene blocks, having 62% by weight of C₂-polyether, 23% by weight of C₃-polyether and 15% by weight of polystyrene, based on the dried dispersing agent, where the ratio of the C₂-polyether and C₃-polyether block lengths is 7:2 units (an example being Disperbyk 190 from BYK-Chemie, Wesel).

The amount present of the dispersing agent is preferably up to 10% by weight, preferably from 3% by weight to 6% by weight, based on the silver content of the particles. Selection of this type of concentration range firstly ensures that the particles are covered with dispersing agent to a sufficient extent to provide the desired properties, e.g. stability of the emulsion. Secondly, according to the invention it avoids excessive sheathing of the particles by the dispersing agent. An unnecessary excess of dispersing agent could have an undesirable adverse effect on the properties of the Pickering emulsion to be produced, and also on those of the coatings to be produced therefrom. An excessive amount of dispersing agent can moreover be disadvantageous for the colloidal stability of the particles and sometimes hinders further processing. An excess of dispersing agents can moreover reduce the conductivity of the coatings produced from the Pickering emulsions or indeed have an insulating effect. According to the invention, all of the previously mentioned disadvantages are advantageously avoided.

With regard to further features of the Pickering emulsion according to the invention, explicit reference is hereby made to the explanations provided in connection with the process according to the invention and in connection with the use according to the invention.

The invention further provides a process for coating all or part of the area of surfaces, where
AA) a Pickering emulsion according to the invention is applied to all or part of the area of a surface,
AB) the surface thus coated is then covered with a covering in such a way that water and solvent can escape,
AC) the coated surface thus covered is then dried at at least one temperature below 40° C. for the removal of the water and of the organic solvent,
AD) the coating thus dried is then sintered in the presence or absence of the covering.

The Pickering emulsion according to the invention can be applied in step (AA) by way of example by spray coating, dipping, flow coating or doctor-application. By way of example, the Pickering emulsion can also be applied by means of a pipette. Surprisingly, it has been found that during application of the Pickering emulsion according to the invention the oil droplets sheathed by silver nanoparticles are retained, with resultant advantageous effect on the self-organization of the silver nanoparticles, and also on the formation of honeycomb structures. Good self-organization of the silver nanoparticles permits formation of continuous structures, without any requirement for complicated printing processes or expensive technology to produce these.

The covering which is placed in step (AB) onto the surface coated with the Pickering emulsion can advantageously firstly have a specific advantageous effect on the rate of drying of the wet layer, thus permitting formation of a continuous network made of silver nanoparticles. Secondly, and surprisingly, it has been found that the covering also promotes the self-organization of the silver nanoparticles, in particular to give honeycomb-shaped structures made of the silver particles. The formation of honeycomb structures made of silver nanoparticles can, according to the invention, achieve not only good conductivity but advantageously also good transparency.

For the removal of the water and of the organic solvent in step (AC) a drying process is carried out at at least one temperature below 40° C. With these drying conditions, which in particular create little thermal stress, and, associated therewith, the slow evaporation of the water and of the organic solvent, it has been found possible to provide particularly good conditions for forming the desired honeycomb structures from the silver nanoparticles. The drying conditions are moreover also suitable for plastics substrates.

For the purposes of one preferred embodiment of the process, the drying in (AC) takes place at at least one temperature below 35° C., particularly preferably at room temperature. The drying step therefore takes place under very mild conditions, and continuously connected network-like honeycomb structures were advantageously formed from the silver nanoparticles.

In another embodiment of the process, the drying in (AC) can take place over a period of from 15 min to 36 h.

For the purposes of another preferred embodiment of the process, the covering can be a glass sheet or plastics sheet, a plastics foil or a synthetic non-woven or textile non-woven, preferably a water- and solvent-permeable covering.

If a covering which is not water- and/or solvent-permeable is used, water and/or solvent can by way of example escape by way of the edge regions between substrate and covering. An example here is a glass microscope slide coated with Pickering emulsion and covered with another glass microscope slide. When this type of substrate-cover arrangement is used, another term used according to the invention is sandwich process.

In one embodiment preferred according to the invention, a water- and solvent-permeable cover can be a porous filter cloth. By way of example, it is possible to use a Monodur polyamide (PA) filter cloth (VERSEIDAG). This is commercially available with various mesh widths and can be selected appropriately for the solvent used. An advantage of this type of filter cloth is that the drying process can take place more uniformly across the area of the substrate than with an impermeable covering. The drying time can moreover be reduced. The results achieved here in relation to the self-organization of the silver nanoparticles to give suitable network structures and honeycomb structures can be just as good as, or indeed better than, in a sandwich process. The extent of adhesion of the silver nanoparticles on this type of covering is moreover comparatively small, and it is therefore possible to achieve a marked reduction of the risk of destroying the silver nanoparticle structures formed, which may not yet have been sintered.

In another preferred embodiment of the process according to the invention for coating all or part of an area, the surface involves the surface of a glass substrate, metal substrate, ceramic substrate or plastics substrate. A plastics substrate can by way of example be one made of polyimide (PI), polycarbonate (PC) and/or polyethylene terephthalate (PET), polyurethane (PU), or polypropylene (PP), where these can optionally have been provided with a primer and/or can have been pretreated with the Pickering emulsion of the invention, for example in order to ensure sufficient wetability. The substrate can moreover preferably be transparent.

For the purposes of another preferred embodiment of the coating process according to the invention, the sintering in (AD) can take place at at least one temperature above 40° C., preferably at at least one temperature of from 80° C. to 180° C., very particularly preferably from 130° C. to 160° C., for example at 140° C. By virtue of comparatively low post-treatment temperatures, it is advantageously also possible even to produce transparent electrically conductive structures on heat-sensitive substrates, for example polycarbonate foils, by using the coating process according to the invention. According to the invention, another possibility, with the low level of thermal stress, is to obtain electronically conductive structures with very good adhesion on substrates such as glass carriers, or else polycarbonate foils. Electrically conductive structures here are in particular structures which have a resistance smaller than 5000 Ω/m. The coatings obtained according to the invention can moreover be transparent, and for various applications this is particularly advantageous.

The invention further provides electrically conductive coatings obtained by a process according to the present invention, where an additional advantage of the said conductive coatings is that they are transparent. Electrically conductive transparent coatings of this type can by way of example form conductor tracks, antenna elements, sensor elements or bonding connections for contacting with semiconductor modules.

The transparent and conductive coatings according to the invention can by way of example be used as transparent electrodes for displays, display screens and touch panels, as electroluminescent displays, as transparent electrodes for contact switches, as transparent shielding for electrodes and auxiliary electrodes, for example for solar cells or in OLEDs, in applications for plastics spectacle lenses, as transparent electrodes for electrochromic layer systems or as transparent electromagnetic shielding. An advantageous possibility here is to replace or supplement the expensive layers and structures made of tin-doped indium oxide (indium tin oxide, ITO).

The examples below serve as examples to illustrate the invention and are not to be interpreted as restricting.

### EXAMPLES

### Analysis Equipment Used

1. Determination of Ag concentration using solids balance: METTLER TOLEDO HG53 Halogen Moisture Analyzer)
2. Determination of rheological properties and of cream layer stability:
   Measurement equipment: MCR301 SN80118503
   Measurement system: CC17-SN7448; d=0 mm
   Measurement profile: 21 measurement points;
   measuring point duration 30 . . . 2 s log
   25° C.
   d(gamma)/dt=0.1 . . . 1E+3 l/s log; |gradient|=5 pt./dec
3. Determination of droplet size distribution and emulsion stability check by means of optical microscope
   LEICA DMLB optical microscope
4. Determination of surface tension by means of ring tensiometer: Ser No: 20002901
5. Dispersion equipment: ULTRA-TURRAX (IKA T 25 digital ULTRA-TURRAX)
6. Dispersion equipment: ultrasonic probe (G. Heinemann, Ultraschall and Labortechnik)
7. Measurement of resistance: Multimeter: METRA Hit 14A
8. UV-VIS spectrophotometer
   HEWLETT 8452 A
   PACKARD diode array spectrophotometer

### Example 1

### Production of a Silver Nanoparticle Sol (Nanosilver Dispersion)

A mixture made of 0.054 molar sodium hydroxide solution and Disperbyk 190 dispersing agent (produced by BYK Chemie, Wesel) (1 g/l) was admixed in a ratio by volume of 1:1 with a 0.054 molar silver nitrate solution, and stirred for 10 min. A 4.6 molar aqueous formaldehyde solution was added, with stirring, to this reaction mixture in such a way that the Ag⁺: reducing agent ratio was 1:10. This mixture was heated to 60° C. and held at this temperature for 30 min, and then cooled. In a first step, the particles were separated from the unreacted starting materials by means of diafiltration. The sol was then concentrated by using a 30 000 daltons membrane. This gave a colloidally stable sol with a solids content of 21.2% by weight (silver particles and dispersing agent). The proportion of Disperbyk 190 according to elemental analysis after the membrane filtration process was 6% by weight, based on silver content. A laser correlation spectroscopy study gave an effective particle diameter of 78 nm.

### Example 2

### Production of the Pickering Emulsion

The silver nanoparticle sol from Example 1, water and organic solvent were mixed and treated with the ultrasonic probe for 3 min at amplitude 50%, and an O/W emulsion was produced. The cream phase was characterized after a standing time of 24 h.

The following were determined: the droplet size distribution, the viscosity, and the surface tension of the Pickering emulsion, and also the solids content of stabilized silver nanoparticles. Table 1 collates the results.

TABLE 1

| | | | Ag solids | | Viscosity of cream | |
|---|---|---|---|---|---|---|
| Ag sol | | | content of | Droplet size | layer [Pa · s] | Surface tension |
| (21.2%) | Water | Cyclohexane | cream layer | distribution | Shear rate 1/s, | of cream layer |
| [ g ] | [ g ] | [ g ] | after 24 h [%] | [μm] | 25° C. | [mN/m] |
| 7.0 | 69.0 | 24.0 | 2.5 | 1-8 | 7.12 | 49 |
| 7.0 | 73.2 | 19.8 | 2.4 | 1-8 | 15.0 | 48 |

### Example 3

### Coating of Substrates

The Pickering emulsions produced from the initial emulsions in Example 2 were applied to a glass microscope slide, and the resultant wet layer was covered with a further glass microscope slide (sandwich process) or by placing a porous, water- and solvent-permeable filter cloth onto the layer, and was dried at temperatures below 35° C. Formation of honeycomb structures made of the silver nanoparticles in the dry films was observed. After removal of the covering, the dry films were sintered at 140° C. for from 4 to 12 h in order to achieve conductivity of the coatings with the honeycomb structures.

A multimeter was used to measure the resistance of the resultant coating between two strips of width about 0.3 cm and length 1 cm separated by 1 cm on the honeycomb film.

Transmittance was determined by means of a UV-VIS spectrophotometer.

### Example 3.1

An Eppendorf pipette was used to apply 500 μl of the cream phase to a glass microscope slide [25 mm/75 mm/1 mm (w/l/t)] and this was covered with, as glass cover (covering), an identical glass microscope slide. The wet film covered by the glass cover was then dried at RT overnight. The water, and also the organic solvent, could escape here by way of the edges of the resultant glass microscope slide sandwich. After the glass cover had been removed, the resultant dry film was sintered at 140° C. for 12 h. Optical microscopy revealed formation of a honeycomb structure. The solids content of stabilized silver nanoparticles in the Pickering emulsion was determined, as also were the conductivity and transmittance of the resultant coating.

Table 2 collates the results.

TABLE 2

| | Ag in the cream layer | Resistance | Transmittance at |
|---|---|---|---|
| Oil phase | [% by weight] | [Ω] | 550 nm [%] |
| Cyclohexane | 2.4 | 48 | 50 |

### Example 3.2

An Eppendorf pipette was used to apply 5000 μl of the cream phase to a glass microscope slide [100 mm/200 mm/4 mm (w/l/t)] and this was covered with, as glass cover (covering), an identical glass microscope slide. The wet film covered by the glass cover was then dried at RT for 5 days. The water, and also the organic solvent, could escape here by way of the edges of the resultant glass microscope slide sandwich. After the glass cover had been removed, the resultant dry film was sintered at 140° C. for 12 h. Optical microscopy revealed formation of a honeycomb structure.

The solids content of stabilized silver nanoparticles in the Pickering emulsion was determined, as also were the conductivity and transmittance of the resultant coating.

Table 3 collates the results.

TABLE 3

| | Ag in the cream layer | Resistance | Transmittance at |
|---|---|---|---|
| Oil phase | [% by weight] | [Ω] | 550 nm [%] |
| Cyclohexane | 2.4 | 145 | 61 |

### Example 3.3

An Eppendorf pipette was used to apply 5000 μl of the cream phase to a glass microscope slide [100 mm/200 mm/4 mm (w/l/t)] and this was applied with a doctor at 200 μm wet layer thickness. A 100 μm mesh width PA filter cloth was placed onto the wet layer. The wet film covered by the filter cloth was then dried at RT for one hour. The water, and also the organic solvent, could escape here through the pores of the filter cloth. After the filter cloth had been removed, the resultant dry film was sintered at 140° C. for 12 h. Optical microscopy revealed formation of a honeycomb structure.

The solids content of stabilized silver nanoparticles in the Pickering emulsion was determined, as also were the conductivity and transmittance of the resultant coating.

Table 4 collates the results.

TABLE 4

| | Ag in the cream layer | Resistance | Transmittance at |
|---|---|---|---|
| Oil phase | [% by weight] | [Ω] | 550 nm [%] |
| Cyclohexane | 2.4 | 60 | 50 |

### Example 3.4

An Eppendorf pipette was used to apply 100 μl of the cream phase to a glass microscope slide [25 mm/75 mm/1 mm (w/l/t)] and this was applied with a doctor at 50 μm wet layer thickness. A 100 μm mesh width PA filter cloth was placed onto the wet layer. The wet film covered by the filter cloth was then dried at RT for 30 min. The water, and also the organic solvent, could escape here through the pores of the filter cloth. After the filter cloth had been removed, the resultant dry film was sintered at 140° C. for 12 h.

This experiment was carried out once with cyclohexane and once with n-hexane as organic solvent to form the oil phase in the Pickering emulsion.

Optical microscopy in each case revealed formation of a honeycomb structure.

The solids content of stabilized silver nanoparticles in the Pickering emulsion was determined, as also were the conductivity and transmittance of the resultant coating.

Table 5 collates the results.

TABLE 5

| | Ag in the cream layer | Resistance | Transmittance at |
|---|---|---|---|
| Oil phase | [% by weight] | [Ω] | 550 nm [%] |
| Cyclohexane | 2.2 | 11 | 61 |
| n-Hexane | 2.6 | 27 | 48 |

### Example 3.5

Coating experiments analogous with the preceding examples using doctor-application or spray coating onto untreated polycarbonate foil were unsuccessful because of poor wetting.

### Example 3.6

An Eppendorf pipette was used to apply 1000 μl of the cream layer to a TiOx-coated polycarbonate foil [100 mm/100 mm/0.17 mm (w/l/t)] and this was applied with a doctor at 100 μm wet layer thickness, good wetting being achieved here. A 100 μm mesh width PA filter cloth was placed onto the wet layer. The wet film covered by the filter cloth was then dried at RT for one hour. The water, and also the organic solvent, could escape here through the pores of the filter cloth. After the filter cloth had been removed, the resultant dry film was sintered at 140° C. for 12 h. This experiment was carried out once with cyclohexane and once with methylcyclohexane as organic solvent to form the oil phase in the Pickering emulsion. Optical microscopy revealed formation of a honeycomb structure.

The solids content of stabilized silver nanoparticles in the Pickering emulsion was determined, as also were the conductivity and transmittance of the resultant coating.

Table 6 collates the results.

TABLE 6

| | Ag in the cream | | |
|---|---|---|---|
| | layer | Resistance | Transmittance at |
| Oil phase | [% by weight] | [Ω] | 550 nm [%] |
| Cyclohexane | 2.4 | 15 | 40 |
| Methylcyclohexane | 2.7 | 133 | 40 |

### Example 4

### Effect of Silver Concentration

The mixtures listed below were produced as described in Example 2 and then applied, dried and sintered as in Example 3. The content of silver nanoparticles in the emulsion was determined. By using a silver paste, two silver points were then applied to the conductive coating at a separation of 1 cm, and the resistance was determined. The droplet size of the emulsion was also determined by optical microscopy. Table 7 collates the results.

TABLE 7

| | Ag sol | | Ag solids content | Droplet size | |
|---|---|---|---|---|---|
| Water | (21.2%) | Cyclohexane | of cream layer after | distribution | Resistance |
| [g] | [g] | [g] | 24 h [% by weight] | [μm] | [Ω] |
| 75.0 | 1.0 | 24.0 | 0.4 | 15-50 | no conductivity |
| 68.0 | 8.0 | 24.0 | 2.4 | 1-8 | 5 |

### Example 5

### Analysis of Silver Content in Cream Phase (Pickering Emulsion)

An Ag sol was first produced by analogy with Example 1, its solids content of silver nanoparticles being 18.5%.

The Pickering emulsions were then produced (ultrasonic probe, 3 min at 50% amplitude) by analogy with Example 2, and in each case the solids content of stabilized silver nanoparticles was determined after 20 h and after five days. It was shown to be possible, specifically for comparatively low starting concentrations of silver nanoparticle sol in the initial emulsion, to obtain an advantageous increase in the concentration of stabilized silver nanoparticles in the cream phase.

Table 8 collates the results.

TABLE 8

| | Ag sol | | Solids content of | Solids content | Solids content in initial |
|---|---|---|---|---|---|
| Water | (18.5%) | Cyclohexane | cream layer after | of cream layer | emulsion, calculated (% |
| [g] | [g] | [g] | 20 h | after 5 days | by weight) |
| 72.0 | 4.0 | 24.0 | 1.33 | 1.10 | 0.74 |
| 68.0 | 8.0 | 24.0 | 2.05 | 2.01 | 1.48 |
| 64.0 | 12.0 | 24.0 | 2.45 | 2.33 | 2.22 |
| 60.0 | 16.0 | 24.0 | 2.76 | 2.74 | 2.96 |
| 49.0 | 27.0 | 24.0 | 3.08 | 3.98 | 5.0 |

1. Process for producing a Pickering emulsion for producing conductive coatings, characterized in that
a) an aqueous dispersion comprising, in particular sterically, stabilized silver nanoparticles and water is mixed with at least one solvent not miscible with water and then is dispersed to give an emulsion, where the content of stabilized silver nanoparticles, based on the total weight of the resultant emulsion, is from 0.5% by weight to 7% by weight, and
b) by virtue of a creaming process during a standing time, the emulsion obtained in (a) is then separated into an upper concentrated emulsion phase and a lower, in essence aqueous, phase, and
c) the resultant upper concentrated emulsion phase is isolated, where the content of silver nanoparticles in this emulsion phase is up to 7% by weight, preferably up to 4.5% by weight, based on its total weight.

2. Process according to claim 1, characterized in that the standing time in (b) is from 1 hour to 5 days.

3. Process according to claim 1, characterized in that the content of silver nanoparticles in the emulsion in (a), based on the total weight of the emulsion obtained in (a), is from 0.7% by weight to 6.5% by weight.

4. Pickering emulsion for producing conductive coatings produced by a process according to claim 1 and characterized in that the emulsion comprises stabilized silver nanoparticles and water, and also at least one organic solvent not miscible with water, where the amount present of the stabilized silver nanoparticles is from 0.5% by weight to 7% by weight, based on the total weight of the emulsion.

5. Pickering emulsion according to claim 4, characterized in that it comprises no additional surfactant compounds, binders, polymers, film-formers, buffers or dispersing agents.

6. Pickering emulsion according to claim 4, characterized in that the organic solvent involves at least one linear or branched alkane, one optionally alkyl-substituted cycloalkane, one alkyl acetate or one ketone, benzene or toluene.

7. Pickering emulsion according to claim 4, characterized in that the organic solvent and the water are present in a ratio by volume of from 1:4 to 1:2 in the emulsion.

8. Pickering emulsion according to claim 4, characterized in that the silver nanoparticles have been sterically stabilized.

9. Process for coating all or part of the area of surfaces, characterized in that
AA) a Pickering emulsion according to claim 4 is applied to all or part of the area of a surface,
AB) the surface thus coated is then covered with a covering in such a way that water and solvent can escape,
AC) the coated surface thus covered is then dried at at least one temperature below 40° C.,
AD) the coating thus dried is then sintered in the presence or absence of the covering.

10. Process according to claim 9, characterized in that the drying in (AC) takes place at at least one temperature below 35° C., preferably at room temperature.

11. Process according to claim 9, characterized in that the drying in (AC) takes place over a period of from 15 min to 36 h.

12. Process according to claim 9, characterized in that the covering involves a glass sheet or plastics sheet, a plastics foil or a synthetic non-woven or textile non-woven, preferably a water- and solvent-permeable covering.

13. Process according to claim 9, characterized in that the surface involves the surface of a glass substrate, metal substrate, ceramic substrate or plastics substrate.

14. Process according to claim 9, characterized in that the sintering in (AD) takes place at at least one temperature above 40° C.

15. Conductive coating produced by a process according to claim 9, characterized in that it is transparent.

16. Process according to claim 9, characterized in that the sintering in (AD) takes place at at least one temperature in the range from 80° C. to 180° C.
